(19) United States
(12) Patent Application Publication
(10) Pub. No.: US 2002/0086638 A1
(43) Pub. Date: Jul. 4, 2002

(54) Internet backbone packet radio

(76) Inventors: Nicholas Sauriol, Nepean (CA); Jun Liu, Nepean (CA); Alex Sauriol, Kanata (CA)

Correspondence Address: James G. Gatto, Esq., Hunton & Williams, Suite 1200, 1900 K Street, N.W., Washington, DC, 20006, US

(21) Appl. No.: 09/749,430

(22) Filed: Dec. 28, 2000

(51) Int. Cl. H04B 1/00

(52) U.S. Cl. 455/45; 455/466; 455/566; 455/186.1

(57) ABSTRACT

The invention provides a technique for transmitting radio programming over a cellular transmission network. In some embodiments, the technique provides a system for making radio programming available in a digital form over a processor based network. The radio programming is then accessed by a cellular transmission system and broadcast to cellular receivers.

### FIELD OF THE INVENTION

The present invention relates to a system and method for broadcasting radio programming over a cellular transmission network. In particular, the invention relates to a system and method for providing radio programming in a digital format, accessing the digital radio programming via a interconnected computer network such as the Internet, and broadcasting the programming over a cellular transmission network.

### BACKGROUND OF THE INVENTION

In existing systems radio programming is traditionally broadcast from transmitters designed to cover a relatively large, but finite, geographic area. Receivers outside of the geographic area are not able to receive the radio programming. This is a disadvantage for listeners, who are unable to receive the programming, and for advertisers, who are unable to reach markets beyond the broadcast area.

In addition, providing digital radio programming is expensive. For example, digital radio broadcast requires expensive new equipment as there is no existing infrastructure for digital radio broadcast. In addition, current systems do not allow for new methods of generating income. Existing systems do not provide enough revenue to warrant the expense of providing digital radio broadcasts.

Another drawback of existing systems is that current radio systems are restricted to very localized transmissions because of, among other things, the limitations on broadcast bandwidth. This limits the number of radio stations that can broadcast in any given geographic region.

### SUMMARY OF THE INVENTION

The invention provides a technique for transmitting radio programming over a cellular transmission network. In some embodiments, the technique provides a system for making radio programming available in a digital form over a processor based network. The radio programming is then accessed by a cellular transmission system and broadcast to cellular receivers.

The invention enables delivery of radio programming to regions outside the normal range of traditional radio broadcast. For example, a radio program listener in Canada may wish to listen to radio programming from Brazil. Ordinarily, the listener would not be able to receive the programming because his location in Canada is far outside the broadcast range of the Brazilian radio station. Embodiments of the present invention enable the Canadian listener to receive the Brazilian program in the following manner. First the Brazilian radio program is uploaded in a digital format onto a processor based network (e.g., the Internet). A cellular radio provider may then access the programming via the internet and forward the programming to a cellular transmission system. The listener in Canada then receives the Brazilian radio program from the cellular transmission network anywhere in the coverage area of the cellular network.

Another feature of the present invention is the ability for radio programming providers to sell advertising space on their programs. In some embodiments, the cellular transmission network may provide transmission of advertising along with the radio programming. For example, cellular receivers with visual display screens may be implemented to receive images, text, or other visual displays that are displayed during the transmission of the radio program.

Another feature of the invention is the ability to reduce the costs of supplying digital radio programming. For example, by taking advantage of the cellular transmission paradigm, embodiments of the invention enable multiple radio programs to be multiplexed and transmitted over a relatively few frequencies. Thus, reducing the bandwidth and power requirements for the transmission.

In addition, because cellular transmissions are individualized (i.e., sent to an identified receiver) the radio programming may be customized to the receiver. For example, the listener may select from a menu of radio programming (e.g., sports programs, different type of music programs, news programs, financial reports, etc.). In addition, cellular radio providers may implement billing schemes that are similarly customized (e.g., pay-per-program, basic program rates, premium program rates, free program minutes, etc.). Likewise, advertising may be customized according to the receiver (e.g., based upon listener selection, listener past purchasing history, listener programming selections, etc.). Of course, cellular radio providers may also sell advertising space according to customized schemes.

In some embodiments, other schemes for producing revenue are possible. For example, cellular radio providers may charge a fee for the transmission of data. In some embodiments, transmitted data may include news information, weather reports, stock market prices, sporting event scores, and other information. The transmitted data may be viewed on a display screen, played back as an audible signal, or otherwise received by the listener.

Some embodiments of the invention may also enable access to the Internet. Internet access may be enabled through a wireless connection scheme provided on the receiver.

These and other embodiments of the present invention will now be described in more detail with reference to exemplary embodiments thereof as shown in the appended drawings. While the present invention is described below with reference to preferred embodiments, it should be understood that the present invention is not limited thereto. Those of ordinary skill in the art having access to the teachings herein will recognize additional implementations, modifications, and embodiments, as well as other fields of use, which are within the scope of the present invention as disclosed and claimed herein, and with respect to which the present invention could be of significant utility.

### BRIEF DESCRIPTION OF THE FIGURES

FIG. 1 is a schematic representation of the overall system according to one embodiment of the invention.

FIG. 2 is a schematic representation of a receiver according to one embodiment of the invention.

FIG. 3 is a flow diagram illustrating a method of implementing cellular radio according to one embodiment of the invention.

### DETAILED DESCRIPTION OF THE FIGURES

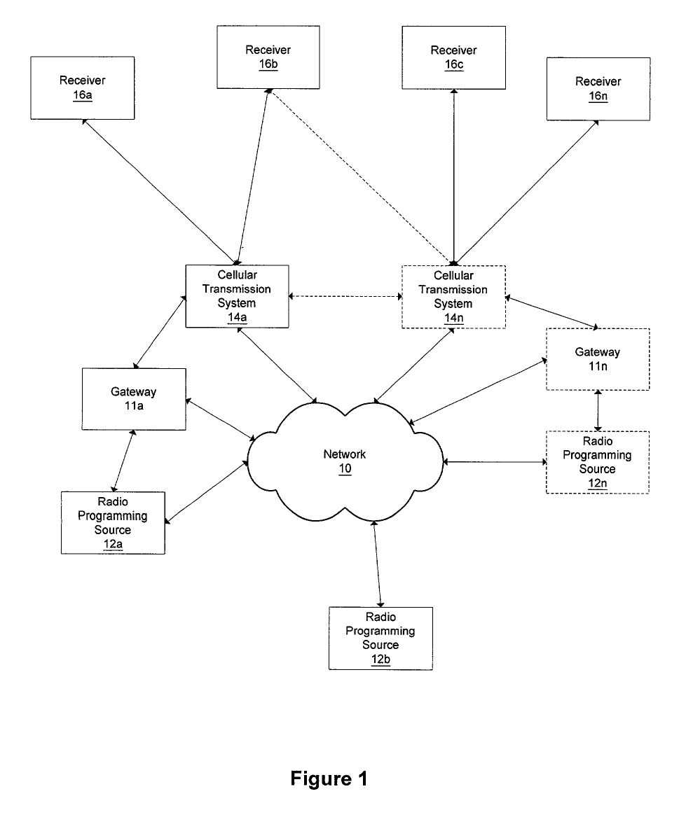

FIG. 1 shows a schematic illustration of one embodiment of the overall cellular radio program transmission system. As shown, the radio programs that are broadcast may originate from any suitable radio programming source (e.g., radio programming source 12a, 12b, . . . , 12n ). As shown in FIG. 1, the system may comprise multiple radio programming sources 12a-12n. The radio programming sources 12a-12n, may be traditional over-the-air radio stations that broadcast in the FM, AM, short wave, or other frequency bands.

In some embodiments, radio programming sources 12a-12n may comprise other sources of digital radio programming. For example, radio programming sources 12a-12n may comprise music, news, sports, financial information, weather reports, talk-shows, comedy programs or other radio programming stored on a computer or other processor based device such as an MP3 server.

Other sources of radio programming are possible.

For example, emergency broadcasts, traffic reports, governmental broadcasts, or the like, may be transmitted over a cellular radio system. In addition, conference centers, hotels, transit stations, or the like may broadcast information over a digital cellular radio system.

In some embodiments, a broadcast gateway 11a-11n may be provided as an interface between the radio programming source (e.g., 12a-12n ) and the end user (e.g., receiver 16a-16n ). For example, gateway 11a 11n may serve as an access device for enabling the radio programming to be accessible over a processor based network (e.g., network 10). For example, broadcast gateway 11a-11n may provide an Internet input interface for broadcast content. In some embodiments, gateway 11a-11n may compress and encodes the content delivering it via existing digital cellular base station equipment (e.g., transmission system 14a-14n ). In addition, gateway Patent 11a 11n may comprise additional inputs that enable the receipt, transmission, routing, and other handling of other network transmission signals. For example, gateway 11a-11n may comprise inputs to process cellular telephone signals. Gateway 11a-11n may also provide billing capabilities.

As shown in FIG. 1, the sources of radio programming 12a-12n may also be in communication with network 10. Network 10 may comprise any suitable processor based network capable of serving the files associated with the radio programming. For example, network 10 may comprise, the Internet, a Wide Area Network (WAN), a Local Area Network (LAN), an intranet, a wireless network, or other network configuration.

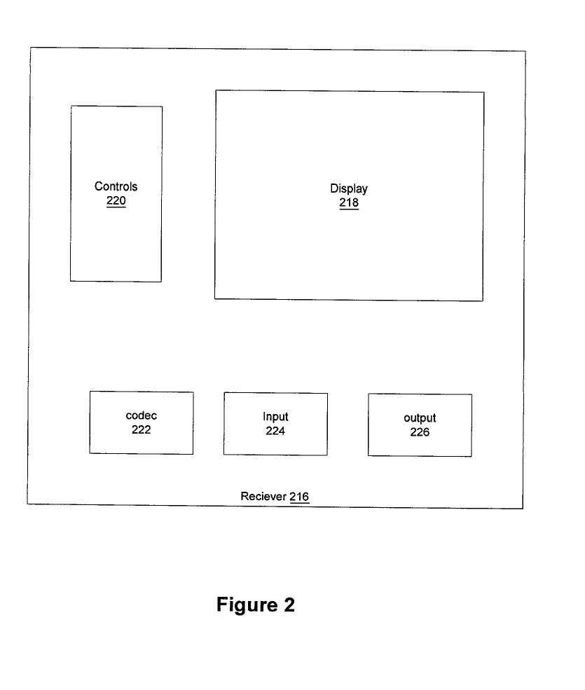

Also in communication with network 10 are cellular transmission systems 14a-14n. As shown, network 10 may communicate with multiple cellular transmission systems 14a, . . . , 14n. In addition, cellular transmission systems 14a-14n may communicate with each other or gateway 11a-11n to coordinate delivery of transmission data. Cellular transmission systems 14a-14n represent the systems that enable the cellular transmissions to be appropriately routed, switched and broadcast to the intended recipients. For example, cellular transmission systems 14a-14n may comprise the routers, switches, antennas, transmitters, software, and other devices used to implement a cellular transmission. Cellular transmission systems 14a-14n deliver the transmission to the designated receiver 16a-16n. Receiver 16a-16n may comprise any device capable of receiving cellular transmissions. For example, receiver 16a-16n may comprise a cellular telephone. In some embodiments, receiver 16a-16n may comprise a cellular radio one example of which is shown in FIG. 2.

FIG. 2 shows a cellular receiver 216 according to one embodiment of the invention. As shown, receiver 216 may comprise a display 218 and controls 220. Display 218 may comprise any form of device capable of showing a visual display. For example, display 218 may comprise a liquid crystal display (LCD) screen, an active matrix display screen, a cathode ray tube (CRT) or any other suitable display device.

In some embodiments, cellular receiver 216 may decode and decompress (e.g., with CODEC 222) the broadcast stream of programming. CODEC 222 may provide a digital audio output 226 for programming content and a digital stream output for non-audio broadcast content (e.g., display 216). The cellular receiver 216 may also provide an input 224 for stream configuration, allowing, for example, the selection, or tuning, of content. Input 224 may also be used for general operational configuration.

As noted above, display 218 may be implemented to display visual images along with the cellular radio transmission. For example, display 218 may be used to display advertising, text, images, graphics, financial information (e.g., stock market activity), sports information (e.g., scores), and other visual information.

Receiver 216 may also include controls 220. Controls 220 provide a user interface to enable controlling the receipt and playback of the cellular transmissions. For example, controls 220 may comprise volume, channel, power, preset stations, number dialing keys, image display controls, audio playback controls, and the like.

Receiver 216 may also comprise a suitable decoder to ensure, among other things, that only the intended receiver 216 receives the programming. For example, the programming may be encoded so that pirating, or unintentional reception of the transmission can be avoided. In addition, a decoder may ensure that received programming can be adequately tracked and billed to the listener.

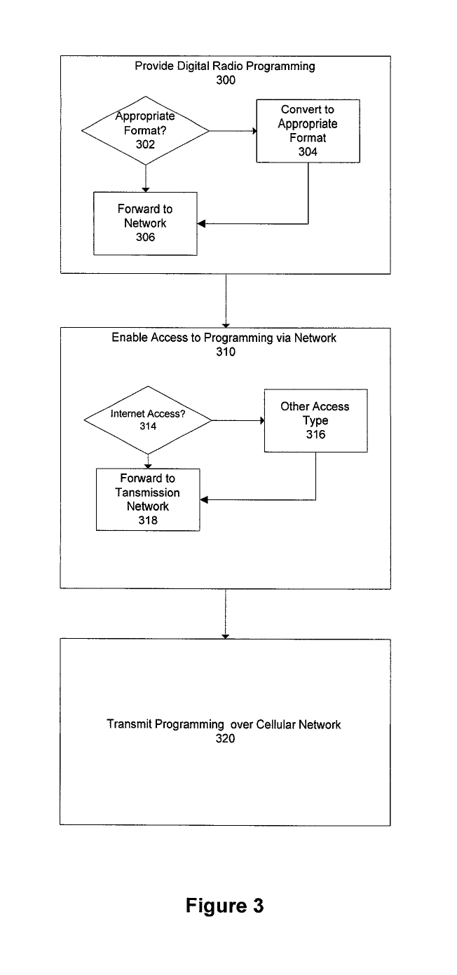

FIG. 3 is a representation of a method for cellular transmission according to one embodiment of the invention. In one embodiment the process may initiate with providing a source of radio programming at step 300. As shown in the Figure, step 300 may comprise a number of sub-steps. For example, a verification of whether the radio programming is in the proper format may be made at step 302. If the format is not proper, it may be converted at step 304. For example, the programming may be converted to a digital format. If the programming is already in the proper format at step 302, or after conversion to the proper format at step 304, the programming may be forwarded to the network (e.g., network 10) at step 306. Forwarding to the network may comprise any procedure that enables the programming to be made available over the network. For example, the programming may be stored in a digital format on a server that is accessible over a network.

Access to the programming via the network is enabled at step 310. As indicated, step 310 may comprise a number of sub-steps. For example, a determination of whether Internet (or other network) access of the programming is possible may be made at step 314. Internet access may comprise enabling downloading of the programming to a transmission network server or other device. If Internet access is not present, the existence of other types of access may be investigated at step 316. Other types of access may include access to stored programming on an Motion Picture Experts Group, Audio Layer 3 (MP3) server or other device.

If it is determined that Internet (or other network) access is available at step 318, or after other type of access at step 316, the accessed programming may be forwarded to a transmission network (e.g., cellular transmission system 14a-14n ) at step 318. Forwarding to a transmission network may include any mechanisms that make the programming available for transmission over the cellular network.

For example, the programming may be up-loaded onto a transmission system server or other device.

At step 320 the programming may be transmitted over the cellular network. Transmission may comprise any steps suitable for enabling transmission of the programming to a cellular receiver.

The present invention is not to be limited in scope by the specific embodiments described herein. Indeed, various modifications of the present invention, in addition to those described herein, will be apparent to those of ordinary skill in the art from the foregoing description and accompanying drawings. Thus, such modifications are intended to fall within the scope of the following appended claims. Further, although the present invention has been described herein in the context of a particular implementation in a particular environment for a particular purpose, those of ordinary skill in the art will recognize that its usefulness is not limited thereto and that the present invention can be beneficially implemented in any number of environments for any number of purposes. Accordingly, the claims set forth below should be construed in view of the full breath and spirit of the present invention as disclosed herein.

What is claimed is:

1. A method for broadcasting radio programming over a cellular transmission network, the method comprising:
providing radio programming in an appropriate format;
enabling the radio programming to be accessible over a processor based network and wherein the processor based network is connectable to a cellular transmission network; and
transmitting the radio programming over the cellular transmission network.

2. The method of claim 1, further comprising:
receiving the radio programming.

3. The method of claim 2, further comprising:
receiving the radio programming with a decoder receiver.

4. The method of claim 1, wherein the cellular transmission network transmits signals over a plurality of channels and the step of transmitting the radio programming further comprises:
transmitting advertising information over at least one of the plurality of channels.

5. The method of claim 4, wherein the step of transmitting advertising information further comprises:
transmitting the advertising information in a format that is displayable as a visual display.

6. The method of claim 1, wherein the cellular transmission network transmits signals over a plurality of channels and the step of transmitting the radio programming further comprises:
transmitting other information over at least one of the plurality of channels.

7. The method of claim 6, wherein the step of transmitting other information further comprises:
transmitting the other information in a format that is displayable as a visual display.

8. The method of claim 1, wherein the step of providing radio programming in an appropriate format further comprises:
accessing a radio station over the Internet.

9. A system for broadcasting a radio program over a cellular transmission network, the system comprising:
a source for providing radio programming in an appropriate format;
an access device for enabling the radio programming to be accessible over a processor based network and wherein the processor based network is connectable to a cellular transmission network; and
a transmitter for transmitting the radio programming over the cellular transmission network.

10. The system of claim 9, further comprising:
a receiver for receiving the radio programming.

11. The system of claim 10, wherein the receiver further comprises:
a decoder receiver for receiving the radio programming.

12. The system of claim 9, wherein the cellular transmission network transmits signals over a plurality of channels and the radio programming further comprises: advertising information that is transmitted over at least one of the plurality of channels.

13. The system of claim 12, wherein the advertising information further comprises:
advertising information in a format that is displayable as a visual display.

14. The system of claim 9, wherein the cellular transmission network transmits signals over a plurality of channels and the radio programming further comprises:
other information transmitted over at least one of the plurality of channels.

15. The system of claim 14, wherein the other information further comprises:
information in a format that is displayable as a visual display.

16. The system of claim 9, wherein the source of providing radio programming further comprises:
a source for accessing a radio station over the Internet.

17. An access device for enabling radio programming to be accessible over a processor based network, the access device comprising:
an input for receiving radio programming;
a converter for converting the radio programming to an appropriate format; and
a delivery module that delivers the radio programming to a cellular transmission network.

18. The access device of claim 17, wherein the processor based network is the Internet.

19. The access device of claim 17, wherein the input further comprises:
an over-air radio broadcast receiver.

20. The access device of claim 17, further comprising:
a signal compressor for compressing a signal associated with the radio programming received as input; and
an encoder for encoding the signal.

21. The access device of claim 17, further comprising:
an additional input for receiving additional cellular transmission network signals.

22. A receiver for receiving a radio programming signal broadcast over a cellular transmission network, the receiver comprising:
an input for receiving the radio programming signal;
an audio output for delivering an audible portion of the radio programming signal; and
a display for displaying a visible portion of the radio programming signal.

23. The receiver of claim 22 further comprising:
a decoder for decoding the radio programming signal.

24. The receiver of claim 22 further comprising:
a decompressor for decompressing the radio programming signal.

25. The receiver of claim 22 further comprising:
an additional input for receiving additional cellular transmission signals.
